(19) United States
(12) Patent Application Publication
(10) Pub. No.: US 2011/0278822 A1
(43) Pub. Date: Nov. 17, 2011

(54) TRAILER TOWING DEVICE OF A PASSENGER CAR

(75) Inventors: Dirk Rainer LUNGERSHAUSEN, Wiesbaden (DE); Gunther HEIM, Lampertheim (DE)

(73) Assignee: GM GLOBAL TECHNOLOGY OPERATIONS LLC, Detroit, MI (US)

(21) Appl. No.: 13/107,172

(22) Filed: May 13, 2011

(30) Foreign Application Priority Data
May 15, 2010 (DE) 102010020648.2

(51) Int. Cl. B60D 1/14

(52) U.S. Cl. 280/495

(57) ABSTRACT

A trailer towing device of a passenger car is provided with a traction force transmission linkage and a removable trailer coupling. The removable trailer coupling is releasably fixed on a central nodal element of the transmission linkage. The transmission linkage includes, but is not limited to two force transmission elements that form two legs of a preferentially isosceles triangle. The tip of the triangle is arranged in a rear tail of the passenger car and comprises the central nodal element. The free ends of the legs are releasably connected to side members of the vehicle body in a front tail of the passenger car.

### CROSS-REFERENCE TO RELATED APPLICATION

This application claims priority to German Patent Application No. 102010020648.2, filed May 15, 2010, which is incorporated herein by reference in its entirety.

### TECHNICAL FIELD

The technical field relates to a trailer towing device of a passenger car with a traction force transmission linkage and a removable trailer coupling. The removable trailer coupling is removably fixed to a central nodal element of the transmission linkage.

### BACKGROUND

A trailer towing device is known from the publication U.S. Pat. No. 6,348,112 B1, wherein the traction force transmission linkage consists of a cross beam, which is arranged in the tail transversely to the driving direction and comprises a central nodal element with which the removable trailer coupling is releasably fixed. At the ends of the cross member plate angles are arranged with which the cross member can be releasably fixed in end regions of side members of the vehicle body.

This known trailer towing device has the disadvantage that the traction forces have to be transmitted via a cross member arranged at a right angle to the side members, which is why for the cross member an ultra high-strength steel alloy is to be provided in order to ensure the safety of the cross member and thus of the central nodal element with the removable trailer coupling arranged therein. Such a cross member not only has the disadvantage of an expensive ultra high-strength steel material but also a considerable weight. In addition to this, such a cross member occupies a space at the end regions of the side members which with modern vehicles is to be provided for a crumbling zone. Such a crumbling zone, because of the high-strength and sturdy material of the cross member, would not guarantee the function of a crumbling zone even with trailer coupling removed, more so since the energy of an impact in the tail would be directly transmitted into the ends of the side members and into the vehicle body by way of the cross member of the trailer towing device, where it would cause considerable body damage.

Accordingly, at least one object is to create a trailer towing device which, despite its high tensile loadability does not impair the function of a crumbling zone in the tail. In addition, other objects, desirable features and characteristics will become apparent from the subsequent detailed description, and the appended claims, taken in conjunction with the accompanying drawings and this background.

### SUMMARY

With an embodiment of the application a trailer towing device of a passenger car with a traction force transmission linkage and a removable trailer coupling is created. The removable trailer coupling is removably fixed to a central nodal element of the transmission linkage. The transmission linkage comprises two force transmission elements which form two legs of a preferentially isosceles triangle. The tip of the typically isosceles triangle is arranged in a rear tail of the passenger car and comprises the central nodal element. The free ends of the legs are releasably connected to side members of the vehicle body in a front tail of the passenger car. Through the shifting of the fixing of a trailer towing device from the rear tail through introduction of force transmission elements which triangularly emanate from the central nodal element in the rear tail and extend to the front tail where they are connected to the side members, crash boxes can now be provided at the ends of the side members in the rear tail in an advantageous manner, which in turn can carry a suitably deformable and energy-absorbing rear bumper or rear transverse bar.

These crash boxes practically constitute an extension of the ends of the side members in the rear tail and can absorb impact energy subject to the consumption of a crumbling zone length without the side members and thus the vehicle body being damaged. In addition, the loading of such force transmission elements compared with a loading of a cross member is reduced through the triangular arrangement of the traction force transmission elements so that for such a traction force transmission linkage light metal alloys such as aluminum alloys or titanium alloys can be used, and thus the dead weight of the vehicle with trailer towing device can be reduced, as a result of which in the case of vehicles operated with fuel the CO₂ emission can be reduced.

In a first embodiment of the application it can be provided that the central nodal element comprises a plate with a front side orientated transversely to the driving direction, on which the force transmission elements are fixed, and a rear orientated in driving direction to the rear, on which the removable trailer coupling and an electrical plug are arranged. Thus, the zone of the vehicle can be designed as crumbling zone as far as to this central nodal element without the side members and thus the body getting damaged. To this end, the central nodal element is arranged at a distance to a rear bumper arranged transversely to the driving direction, so that this distance between the back of the rear bumper and the rear of the central nodal element can be provided for a crumbling zone length of the crash boxes. Only after the consumption of this crash zone length and the energy removal of an impact connected with this will energy in the front tail be transmitted to the side members and thus to the body via the central nodal element and the traction force transmission linkage. Prerequisite for this is that the trailer coupling is removable from the central nodal element.

Since the traction force transmission linkage is only fixed with the side members in the front tail a substantial rotational moment loading on the fixing positions results from the support weight of a trailer on the trailer coupling arranged in the rear tail. In order to reduce this rotational moment loading a spring-elastic connecting element is arranged between a back of the rear bumper and the rear of the central nodal element. This comprises the advantage that the rear bumper supports the central nodal element for the trailer coupling in vertical direction and thus absorbs a part of the support load of the trailer coupling acting in vertical direction.

In order to satisfy this object, the connecting element between central nodal element and rear bumper comprises a spring-elastic steel band which is bent U-shaped. The spring-elastic steel band typically has a first vertically orientated leg which is fixed on the rear of the central nodal element and a second vertically orientated leg, which is fixed on the back of the rear bumper, wherein between the legs a base is arranged which bridges the distance between the rear of the central nodal element and the back of the rear bumper. Because of the elasticity of this connecting element the crumbling zone function of rear bumper and crash boxes is not impaired and these components of the crumbling zone are nevertheless utilized in order to support the trailer towing device and reduce the rotational moment load on the traction force transmission linkage.

In addition, it is provided for an embodiment of the application that at the rear of the plate of the central nodal element a latching opening for the removable trailer coupling with a locking mechanism is arranged, in which the removable trailer coupling engages on sliding into the latching opening. In addition to the materials for the transmission linkage already mentioned above it is also possible to employ a tubular or band-shaped, fiber-reinforced plastic material as transmission linkage and to achieve a weight saving by using carbon fibers in the fiber-reinforced plastic material.

A further possibility of saving weight without impairing the tensile strength of the trailer towing device consists in achieving a floor plate of the tail or a floor structure for absorbing tensile loads of the trailer towing device in that the transmission linkage is integrated in the floor plate of a luggage compartment region. To this end, the force transmission elements in the form of half tubes can be materially connected to the floor plate of the luggage compartment region. Because of this, the trailer load, which acts on the central nodal element, is absorbed by the luggage compartment floor in an advantageous manner so that a spring-elastic connection to the rear bumper can be omitted.

In a further embodiment of the application the central nodal element comprises a hollow tube section orientated in longitudinal direction of the passenger car, on whose cylindrical surface the legs of the transmission linkage are materially fixed. This hollow tube section can be simultaneously provided for receiving the locking mechanism of the removable trailer coupling. Furthermore it is provided that between the legs of the transmission linkage a transverse tube is arranged in order to improve the transverse stability of the transmission linkage and prevent buckling of the transmission linkage upon transverse loading on the central nodal element.

Furthermore, the fixings of a cross member in the rear axle region can be utilized for a Watt linkage in order to also releasably connect the ends of the legs of the transmission linkage to the side members of the vehicle body thereon. A Watt linkage serves for the parallel guidance of rear wheels on a crank linkage and comprises the cross member on which a central holder for a hinged upper and a hinged lower cross link is arranged, wherein the cross links ensure the parallel guidance of the rear wheels.

Since the removable trailer coupling is exposed to increased loads it is preferentially processed as drop-forged component and preferentially comprises a drop-forged steel alloy. The legs of the transmission linkage, which forms the force transmission elements of the trailer towing device from the central nodal element to the side members are matched to the underbody and the substructure of the vehicle and consequently also comprise curves in the course of the legs. Nevertheless, the orientation of the structure of the transmission linkage of an isosceles triangle upon top view of the transmission linkage is retained.

### BRIEF DESCRIPTION OF THE DRAWINGS

The present invention will hereinafter be described in conjunction with the following drawing figures, wherein like numerals denote like elements, and:

FIG. 1 shows a schematic perspective view of a tail of a passenger car with a trailer towing device according to a first embodiment of the application;

FIG. 2 shows a schematic, partially longitudinally cut view of the trailer towing device according to FIG. 1;

FIG. 3 shows a schematic top view of a tail of a passenger car with a trailer towing device according to a second embodiment of the application;

FIG. 4 shows a schematic perspective view of the trailer towing device according to FIG. 3;

FIG. 5 shows a schematic perspective bottom view of a tail of a passenger car with trailer towing device of a third embodiment of the application;

FIG. 6 shows a schematic, partially longitudinally cut view of the trailer towing device according to FIG. 5; and

FIG. 7 shows a schematic, partially transversely cut view of the trailer towing device according to FIG. 5.

### DETAILED DESCRIPTION

The following detailed description is merely exemplary in nature and is not intended to limit application and uses. Furthermore, there is no intention to be bound by any theory presented in the preceding background or summary or the following detailed description.

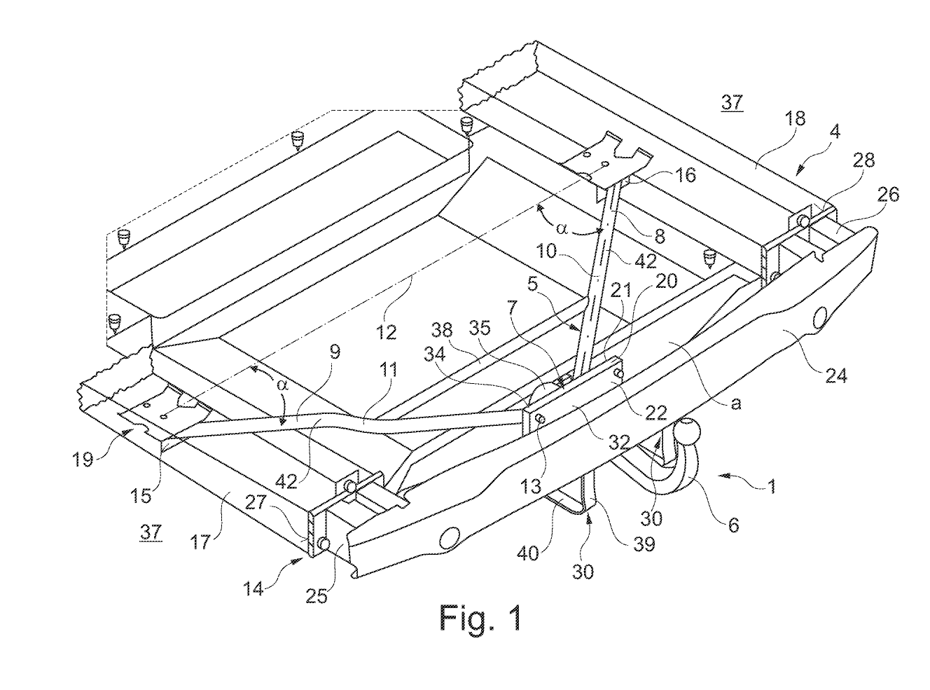

FIG. 1 shows a schematic perspective view of a tail of a passenger car 4 with a trailer towing device 1 according to a first embodiment. The trailer towing device 1 comprises a removable trailer coupling 6. This removable trailer coupling 6 is inserted in a latching opening 32 of a rear 22 of a central nodal element 7. This central nodal element 7 is arranged at a distance a from a rear bumper 24, which together with two crash boxes 25 and 26 forms a crumbling zone. This crumbling zone is to dampen an impact energy on the tail of the passenger car before the lateral side members 17 and 18, to whose ends 27 and 28 the crash boxes 25 and 26 are screwed, and the body of the vehicle are damaged. The distance a between the rear bumper 24 and the central nodal element 7 is so dimensioned that the crumbling zone length of the crash boxes 25 and 26 can be unimpededly utilized for the removal of the impact energy. Only after the compression of the crumbling zone length of the crash boxes 25 and 26 will the bumper 24 abut the central nodal element 7 of the trailer towing device 1 connected to the side members.

The central nodal element 7 comprises a plate 20 with a front side 21 arranged transversely to the driving direction and the rear 22 as well as with the latching opening 32 for the removable trailer coupling 6 mentioned above. On the plate 20 a hollow tube section 34 with a cylindrical surface 35 is arranged in driving direction, wherein on the cylindrical surface 35 two force transmission elements 8 and 9 of the trailer towing device 5 are welded on, which form the legs 10 and 11 of an isosceles triangle. The force transmission elements 8 and 9 transmit the traction forces from the central nodal element 7 in the rear tail 14 to a front tail 19 and are releasably connected to the side members 17 in the front tail 19. The isosceles triangle 12 of this fraction force transmission linkage 5 is arranged in such a manner that the traction force is not introduced into the side members 17 and 18 at the ends 27 and 28, but in a rear axle region 37 of the front tail 19. In order to adapt the traction force transmission linkage 5 to the floor structure in the tail of the vehicle, the force transmission elements 8 and 9 have curves 42 which however do not impede the division of the force flow of the traction force into the two legs 10 and 11 of the isosceles triangle 12.

The tip 13 of the isosceles triangle 12 forms the central nodal element 7. In order to absorb the transverse forces in the traction force transmission linkage 5 when cornering, a cross member 38 is additionally arranged between the two legs 10 and 11. In order to absorb the coupling load of the trailer on the trailer coupling 6 and thus on the central nodal element 7, a spring-elastic connecting element 30 each is arranged laterally of the removable trailer coupling 6, which connect the central nodal element 7 to a back side of the rear bumper 24. Thus, the vertical coupling load on the removable trailer coupling 6 is absorbed by the rear bumper 24 without the effectiveness of the crumbling zone being diminished. To this end, the connecting elements 30 are produced from a spring-elastic band bent in the shape of a U. The legs of the U-shaped band, of which the leg 39 is visible in FIG. 1, are orientated vertically and on the one side connected to the back side of the rear bumper 24 and on the other side to the rear 22 of the plate 20 of the central nodal element s7, while the base 40 of the U-shaped connecting element 30 bridges the distance a between the rear bumper 24 and the central nodal element 7.

With this spring-elastic connecting element 30 the bending load in the region of the ends 15 and 16 of the force transmission elements 8 and 9 on the side members 17 and 18 is reduced. Thus, following the assembly of the spring-elastic connecting elements 30, the rear bumper 24 with its crash boxes 25 and 26 forms a carrying part of the trailer towing device 1 without impairing the effectiveness of the crumbling zone in the tail.

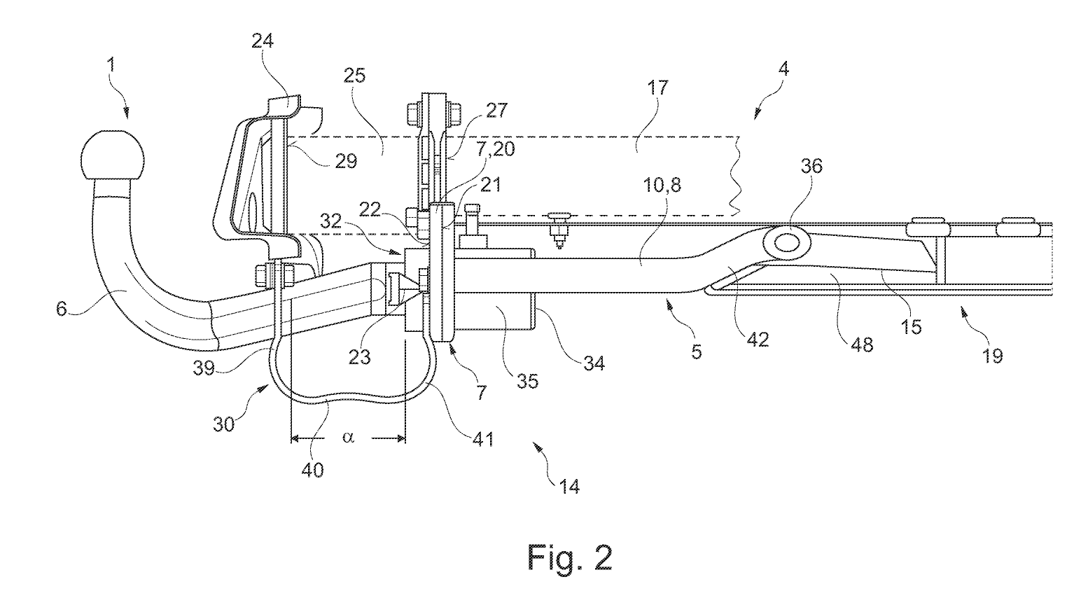

FIG. 2 shows a schematic, partially longitudinally cut view of the trailer towing device 1. There, to illustrate that the side member 17 with its end 27 and the crash box 25 connected thereto, which is connected to the rear bumper 24, are not arranged in the plane of the trailer coupling 6, this region is marked with interrupted lines. In this cross section the floor structure 48 is merely sketched in the tail and the structure of the central nodal element 7 arranged relative to the floor structure 48 as well as the traction force transmission linkage 5. The force transmission element 8 of the traction force transmission linkage 5 is welded onto the cylindrical surface 35 of the hollow tube section 34 and the removable trailer coupling 6 is inserted into the hollow tube section 34 via a latching opening 32. In addition to this, an electrical plug 23 is sketched in this view via which an electrical connection can be established between trailer and vehicle.

Decisive for the mechanical construction is the U-shaped structure of a spring-elastic connecting element 30 between the coupling element 7 and a back side 29 of the rear bumper 24 for bridging the distance a and in order to largely absorb the trailer load vertically acting on the removable trailer coupling 6 by the rear bumper 24. To this end, the U-shaped connecting element 30 is produced of a band material, wherein a first leg 39 is releasably connected to the back side 29 of the rear bumper 24 and a second leg 41 of the spring-elastic connecting element 30 is releasably fixed with the rear 22 to the plate 20 of the central nodal element 7 and the base 40 bridges the distance a between the back side 29 of the rear bumper 24 and the rear 22 of the central nodal element 7.

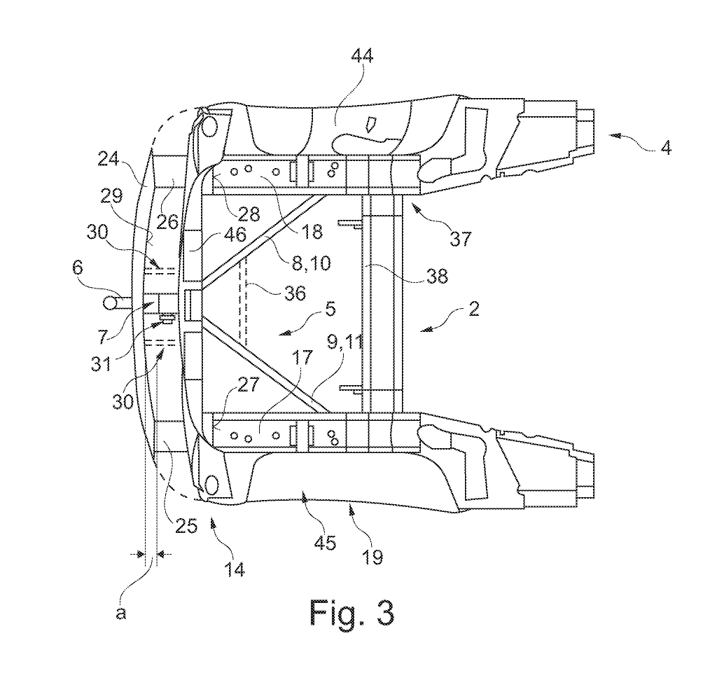

FIG. 3 shows a schematic top view of a tail of a passenger car 4 with a trailer towing device 2 according to a second embodiment. This top view clearly shows the rear axle region 37 with the two rear wheelhouses 44 and 45 and the side members 17 and 18 as well as a further cross member 38 which connects the side members 17 and 18 in the front tail 19 and forms the cross member 38 for a Watt linkage. On the connecting points of the cross member 38 with the side members 17 and 18 the ends of the force transmission elements 8 and 9 of the traction force transmission linkage 5 which are not visible here are simultaneously fixed with the screw connections provided for the cross member 38.

The trailer load resting on the trailer coupling 6 in this embodiment is largely accepted by a connection with a cross member 46 comprising a luggage compartment lock 50, so that the spring-elastic connecting elements 30 known from FIG. 1 are merely provided optionally between the back side 29 of the rear bumper 24 and the coupling element 7, which is why the spring-elastic connecting elements 30 are marked with interrupted lines. In this embodiment of the invention, an operating element of the locking device 31 for the removable trailer coupling 6 can be seen on the coupling element 7. The transverse tube 36 between the force transmission elements 8 and 9 provided in FIG. 1 is also provided only optionally in this embodiment of the invention and marked with interrupted line in this FIG. 3.

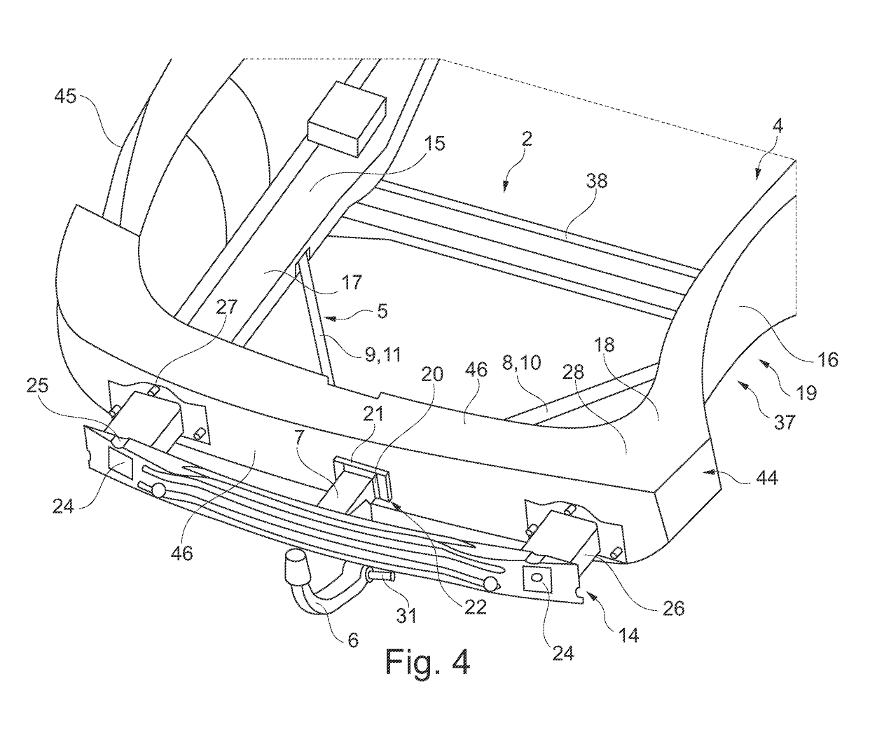

FIG. 4 shows a schematic perspective view of the trailer towing device according to FIG. 3, wherein the FIG. 4 shows that the trailer towing device 1 with its central nodal element 7 is integrated in the cross member construction 46 of the tail, so that in principle spring-elastic connecting elements to the rear shock absorber 24 can be omitted. It is additionally evident from FIG. 4 that the free ends 15 and 16 of the legs 10 and 11 of the traction force transmission linkage 5 are connected to the rear axle region 37.

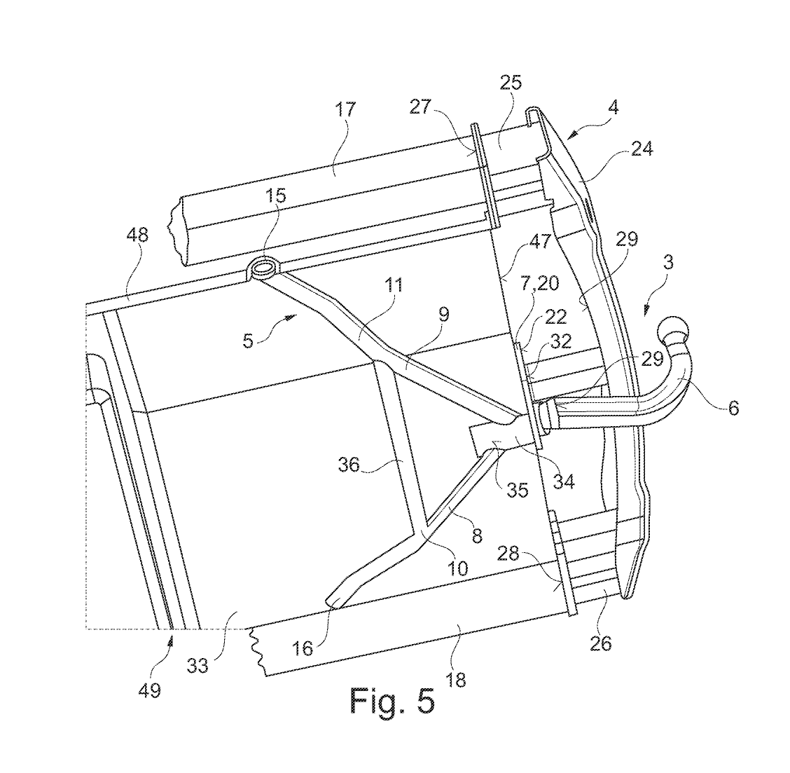

FIG. 5 shows a schematic perspective bottom view of a tail of a passenger car 4 with trailer towing device 3 of a third embodiment of the application. To this end, the traction force transmission linkage 5 is integrated with its two force transmission elements 8 and 9 as well as the transverse tube 36 in a floor plate 33 of the luggage compartment region, so that with this construction, too, the absorbing of the central nodal element s7 with the help of spring-elastic connecting elements to the rear bumper 24 is no longer required, since this is taken over by the rear front 47 of the floor structure 48 of the luggage compartment 49.

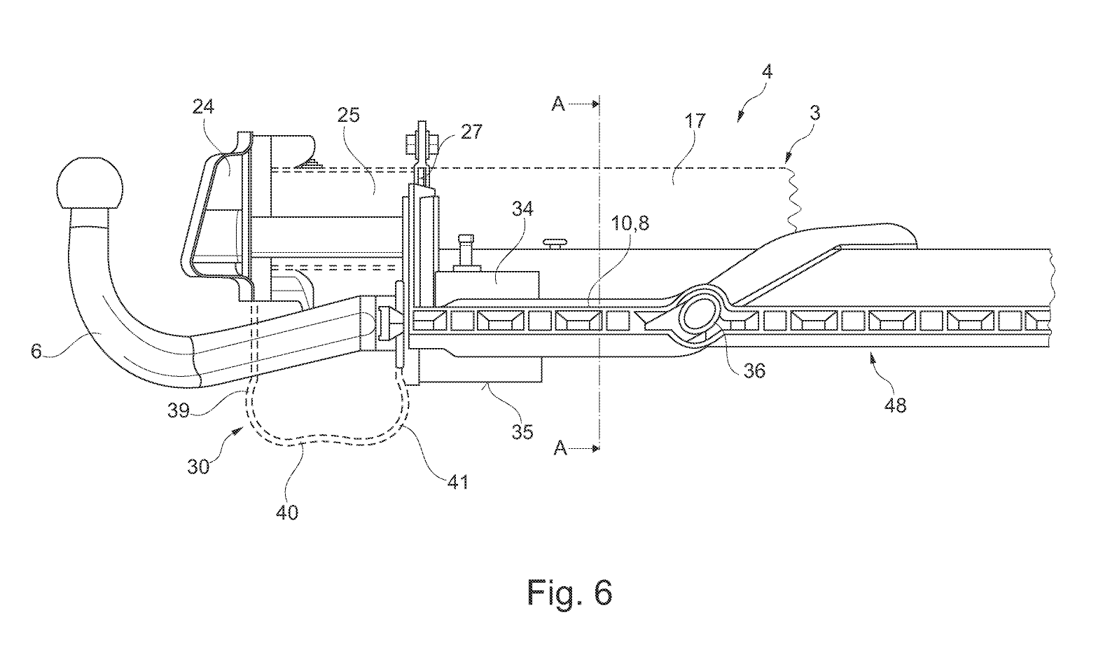

FIG. 6 shows a schematic partially longitudinally cut view of the trailer towing device 3 according to FIG. 5. The elements not located in the longitudinal section plane, such as the crash box 25, the side member 17 with its end 27, onto which the crash box 25 is flanged, are drawn with interrupted line. In the floor structure 48 both the transverse tube 36 as well as the force transmission elements are integrated, while the force transmission element 8 is welded onto the cylindrical surface of the hollow tube section 34, which is likewise integrated in the floor structure 48. Since the floor structure 48 is suitable to absorb the vertical coupling load, a spring-elastic connecting element 30 can be additionally arranged as an option between rear bumper 25 and the central nodal element 7, wherein the position of the connecting element 30 is indicated with interrupted lines.

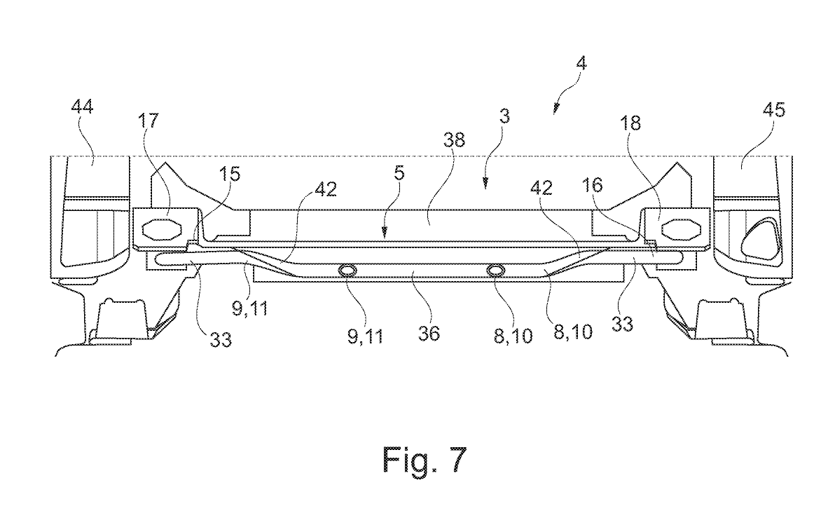

FIG. 7 shows a schematic, partially transversely cut view along the section plane A-A of FIG. 6 through the trailer towing device 3 according to FIG. 5. With this FIG. 7 it becomes clear how the traction force transmission linkage is integrated in the floor plate 33 and the ends 15 and 16 are fixed on the side members 17 and 18 in the region of the rear wheelhouses 44 and 45. With this transverse section along the line A-A in FIG. 6, the force transmission elements 8 and 9, which in this case are visible as light metal hollow tubes, are cut transversely so that, since they form the legs of an isosceles triangle, appear elliptical in cross section.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A trailer towing device of a passenger car; comprising:
a traction force transmission linkage; and
a removable trailer coupling that is removably fixed to a central nodal element of the traction force transmission linkage,
wherein the traction force transmission linkage comprises two force transmission elements that are two legs of a triangle, and
wherein a tip of the triangle comprises the central nodal element in a rear tail of the passenger car and free ends of the two legs are releasably connected to side members of a car body in a front tail of the passenger car.

2. The trailer towing device according to claim 1,
wherein the central nodal element comprises a plate with a front side orientated transversely to a driving direction on which force transmission elements are fixed, and
wherein the removable trailer coupling and an electrical plug are arranged on a rear orientated in the driving direction to the rear.

3. The trailer towing device according to claim 1,
wherein the central nodal element is arranged at a distance to a rear bumper arranged transversely to a driving direction, and
wherein the rear bumper is fixed via crash boxes to ends of the side members.

4. The trailer towing device according to claim 3, wherein the distance between the rear bumper and the central nodal element is arranged to correspond to a crumbling zone length of the crash boxes.

5. The trailer towing device according to claim 3, wherein a spring-elastic connecting element is arranged between a back side of the rear bumper and the rear of the central nodal element.

6. The trailer towing device according to claim 5, wherein the spring-elastic connecting element comprises a spring-elastic steel band that is bent in a U-shaped.

7. The trailer towing device according to claim 1, wherein the central nodal element is arranged on a rear of a latching opening for the removable trailer coupling with a locking mechanism in which the removable trailer coupling engages when inserted in the latching opening.

8. The trailer towing device according to claim 1, wherein the traction force transmission linkage comprises a tubular fiber-reinforced plastic material.

9. The trailer towing device according to claim 1, wherein the traction force transmission linkage is integrated in a floor plate of a luggage compartment region.

10. The trailer towing device according to claim 1, wherein the central nodal element comprises a hollow tube section orientated in longitudinal direction of the passenger car, on whose cylindrical surface the two legs of the fraction force transmission linkage are materially fixed.

11. The trailer towing device according to claim 1, wherein a transverse tube is arranged between the two legs of the traction force transmission linkage.

12. The trailer towing device according to claim 8, wherein the ends of the two legs are releasably fixed to the side members in a rear axle region.

13. The trailer towing device according to claim 8, wherein the ends of the two legs are releasably arranged on the side members in a rear axle region together with positions for fixing a cross member of Watt linkages.

14. The trailer towing device according to claim 1, wherein the removable trailer coupling comprises a drop-forged iron alloy.

15. The trailer towing device according to claim 1, wherein the traction force transmission linkage comprises a curvature for height compensation between a vehicle underbody and a side member bottom edge.
